(19) United States
(12) Patent Application Publication
(10) Pub. No.: US 2016/0203086 A1
(43) Pub. Date: Jul. 14, 2016

(54) DATA PROTECTION METHOD, MEMORY CONTROL CIRCUIT UNIT AND MEMORY STORAGE DEVICE

(71) Applicant: PHISON ELECTRONICS CORP., Miaoli (TW)

(72) Inventors: Hon-Wai Ng, Hsinchu City (TW); Jen-Wei Lo, Hsinchu City (TW); Chien-Fu Lee, Yunlin County (TW); Chia-Jung Hsu, Hsinchu County (TW)

(21) Appl. No.: 14/641,441

(22) Filed: Mar. 9, 2015

(30) Foreign Application Priority Data
Jan. 12, 2015 (TW) 104100960

(51) Int. Cl. G06F 12/14; G06F 12/08

(52) U.S. Cl. CPC G06F 12/1408; G06F 12/0802; G06F 2212/1052; G06F 2212/6022

(57) ABSTRACT

The present disclosure provides a data protection method, a memory control circuit unit and a memory storage device. The data protection method includes: establishing a security channel with a electronic device through a wireless communication network; acquiring an identification code through the security channel established on the wireless communication network; acquiring an encryption/decryption key by using the identification code and storing the encryption/decryption key in a buffer memory; decoding the data read from the rewritable non-volatile memory by using the encryption/decryption key, and the data in the rewritable non-volatile memory is encoded by using the encryption/decryption key; detecting whether an acknowledgement signal is received from the security channel established through the wireless communication network; and erasing the encryption/decryption key stored in the buffer memory if the acknowledgement signal is not received from the electronic device within a predetermined period of time.

### CROSS-REFERENCE TO RELATED APPLICATION

This application claims the priority benefit of Taiwan application serial no. 104100960, filed on Jan. 12, 2015. The entirety of the above-mentioned patent application is hereby incorporated by reference herein and made a part of this specification.

### BACKGROUND

1. Technical Field

The disclosure relates to a data protection method for a rewritable non-volatile memory module, and a memory control circuit unit and a memory storage device using the data protection method.

2. Related Art

Flash drive is a data storage device, in which a flash memory is generally used as a storage medium. The flash memory is an electrically erasable programmable read only memory (EEPROM), which has advantages of programmability, erasability and capable of storing data after power-off. Moreover, the flash memory is one of non-volatile memories, which as advantages of small volume, fast accessing speed and low power consumption, and since data erasing thereof adopts an erasing method of “block by block”; the flash memory has a fast operation speed. Since the flash drive has a small volume, a large capacity and is easy to carry, it is widely applied for storing personal data. However, when the flash drive is accidentally lost, the large amount of data stored therein is probably stolen.

In order to resolve the above problem, manufacturers have developed wireless fidelity (Wi-Fi) flash drives, secure digital (SD) cards, Wi-Fi wireless card readers and wireless external hard drive boxes, etc., in which a secure mechanism such as Wi-Fi protected access personal (WPA-Personal), etc. is set. However, in such secure mechanism, various devices implement connections by using a shared key, so that each user sharing the network can steal or tamper data of others. Therefore, it is a problem to be resolved to ensure security of the memory storage device under a wireless communication network environment.

Nothing herein should be construed as an admission of knowledge in the prior art of any portion of the present invention. Furthermore, citation or identification of any document in this application is not an admission that such document is available as prior art to the present invention, or that any reference forms a part of the common general knowledge in the art.

### SUMMARY

The disclosure is directed to a data protection method, a memory control circuit unit and a memory storage device, in which a security channel established in a wireless communication network is used to transmit an identification code, and the identification code is used to generate an encryption/decryption key to read the memory storage device, so as to improve security of the memory storage device.

An exemplary embodiment of the disclosure provides a data protection method, which is adapted to protect data of a rewritable non-volatile memory module in a memory storage device. The data protection method includes establishing a security channel with an electronic device through a wireless communication network; acquiring an identification code through the security channel established on the wireless communication network; using the identification code to acquire an encryption/decryption key, and storing the encryption/decryption key in a buffer memory. The data protection method still includes using the encryption/decryption key to decode data read from the rewritable non-volatile memory module, wherein the data in the rewritable non-volatile memory module is encoded by using the encryption/decryption key. The data protection method further includes detecting whether an acknowledgement signal is received from the electronic device through the security channel established on the wireless communication network; erasing the encryption/decryption key stored in the buffer memory if the acknowledgement signal is not received from the electronic device within a predetermined period of time.

An exemplary embodiment of the disclosure provides a memory control circuit unit, which is configured to control a rewritable non-volatile memory module, and includes a host interface, a memory interface, a memory management circuit and a wireless communication interface. The host interface is coupled to a host system. The memory interface is coupled to the rewritable non-volatile memory module. The memory management circuit is coupled to the host interface and the memory interface. The wireless communication interface is coupled to the memory management circuit. The memory control circuit unit establishes a security channel with an electronic device through a wireless communication network via the wireless communication interface. The wireless communication interface acquires an identification code through the security channel established on the wireless communication network. The memory management circuit uses the identification code to acquire an encryption/decryption key, and stores the encryption/decryption key in a buffer memory. The memory management circuit uses the encryption/decryption key to decode data read from the rewritable non-volatile memory module, where the data in the rewritable non-volatile memory module is encoded by using the encryption/decryption key. The wireless communication interface detects whether an acknowledgement signal is received from the electronic device through the security channel established on the wireless communication network. The memory management circuit erases the encryption/decryption key stored in the buffer memory if the wireless communication interface does not receive the acknowledgement signal from the electronic device within a predetermined period of time.

An exemplary embodiment of the disclosure provides a memory storage device including a connection interface unit, a rewritable non-volatile memory module, a memory control circuit unit and a wireless communication interface. The connection interface unit is coupled to a host system. The memory control circuit unit is coupled to the connection interface unit and the rewritable non-volatile memory module. The wireless communication interface is coupled to the memory control circuit unit. The memory control circuit unit establishes a security channel with an electronic device through a wireless communication network via the wireless communication interface. The memory control circuit unit acquires an identification code through the security channel established on the wireless communication network. The memory control circuit unit uses the identification code to acquire an encryption/decryption key, and stores the encryption/decryption key in a buffer memory. The memory control circuit unit uses the encryption/decryption key to decode data read from the rewritable non-volatile memory module, where the data in the rewritable non-volatile memory module is encoded by using the encryption/decryption key. The memory control circuit unit detects whether an acknowledgement signal is received from the electronic device through the security channel established on the wireless communication network. The memory control circuit unit erases the encryption/decryption key stored in the buffer memory if the memory control circuit unit does not receive the acknowledgement signal from the electronic device within a predetermined period of time.

According to the above descriptions, in the data protection method of the disclosure, the identification code is acquired from the electronic device through the security channel established on the wireless communication network, and the encryption/decryption key is acquired by using the identification code and an encrypted key pre-stored in the memory storage device, and the data stored in the memory storage device is decoded by using the encryption/decryption key. If the acknowledgement signal is not received from the security channel within the predetermined period of time, it is determined that the memory storage device is away from the electronic device, and the encryption/decryption key is erased, and the memory storage device is set to a non-media state.

It should be understood, however, that this Summary may not contain all of the aspects and embodiments of the present invention, is not meant to be limiting or restrictive in any manner, and that the invention as disclosed herein is and will be understood by those of ordinary skill in the art to encompass obvious improvements and modifications thereto.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of a host system, a memory storage device and an electronic device according to an exemplary embodiment.

FIG. 2 is a schematic diagram of a host system and an input/output device according to an exemplary embodiment.

FIG. 3 is a schematic diagram of a host system and a memory storage device according to an exemplary embodiment.

FIG. 4 is a schematic block diagram of a memory storage device of FIG. 1.

FIG. 5 is a schematic block diagram of a memory control circuit unit according to an exemplary embodiment.

FIG. 6 is a flowchart illustrating a data protection method according to an exemplary embodiment.

FIG. 7 is a flowchart illustrating a data protection method according to another exemplary embodiment.

### DETAILED DESCRIPTION OF DISCLOSED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Embodiments of the present invention may comprise any one or more of the novel features described herein, including in the Detailed Description, and/or shown in the drawings. As used herein, “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

It is to be noted that the term “a” or “an” entity refers to one or more of that entity. As such, the terms “a” (or “an”), “one or more” and “at least one” can be used interchangeably herein.

Generally, a memory storage device (which is also referred to as a memory storage system) includes a rewritable non-volatile memory module and a controller (which is also referred to as a control circuit). The memory storage device is generally used together with a host system, such that the host system can write data into the memory storage device or read data from the memory storage device.

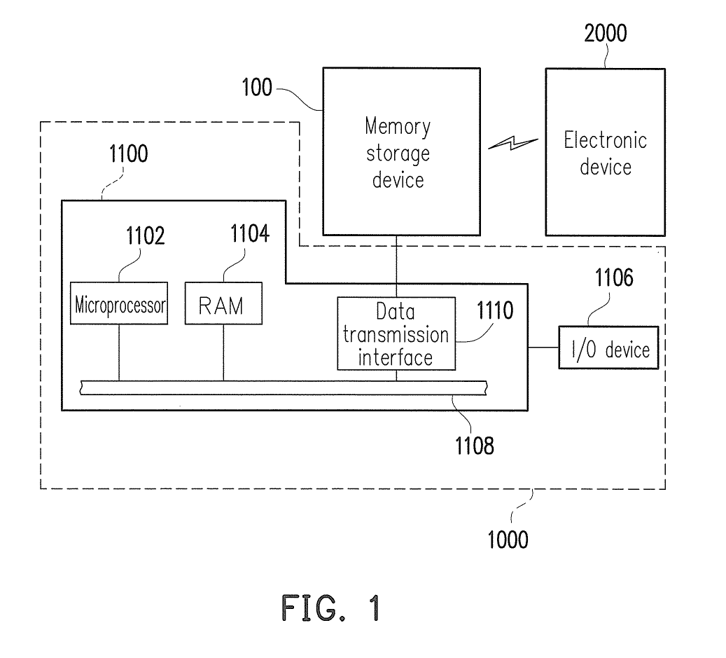

FIG. 1 is a schematic diagram of a host system, a memory storage device and an electronic device according to an exemplary embodiment.

Referring to FIG. 1, the electronic device 2000 can be a portable electronic device such as a mobile phone, a tablet personal computer (PC), etc., and can implement wireless communication with the memory storage device 100 through a wireless network. The electronic device 2000 can also be a server, which can implement wireless communication with the memory storage device 100 through a wireless network access point. However, the disclosure is not limited thereto, and the electronic device 2000 can also be other device having a wireless communication network function, which can implement wireless communication with the memory storage device 100 through the wireless network.

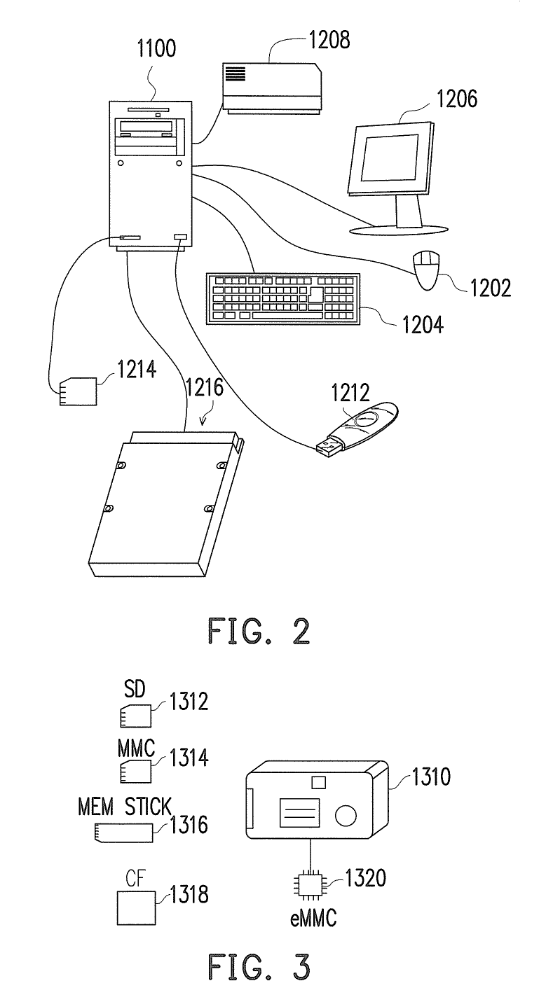

The host system 1000 generally includes a computer 1100 and an input/output (IO) device 1106. The computer 1100 includes a microprocessor 1102, a random access memory (RAM) 1104, a system bus 1108 and a data transmission interface 1110. The I/O device 1106 includes a mouse 1202, a keyboard 1204, a display 1206 and a printer 1208 shown in FIG. 2. It should be noticed that the devices shown in FIG. 2 are not used to limit the I/O device 1106, and the I/O device 1106 may also include other devices.

In an exemplary embodiment, the memory storage device 100 is coupled to the other devices of the host system 1000 through the data transmission interface 1110. Based on operations of the microprocessor 1102, the RAM 1104, and the I/O device 1106, data can be written into the memory storage device 100 or read from the memory storage device 100. For example, the memory storage device 100 can be a rewritable non-volatile memory storage device such as a flash drive 1212, a memory card 1214 or a solid state drive (SSD) 1216 shown in FIG. 2.

Generally, the host system 1000 can be any system substantially used together with the memory storage device 100 for storing data. In the present exemplary embodiment, although the host system 1000 implemented by a computer system is taken as an example, in another exemplary embodiment of the present disclosure, the host system 1000 can also be a digital camera, a video camera, a communication device, an audio player or a video player, etc. For example, when the host system is a digital camera (video camera) 1310, the rewritable non-volatile memory storage device is a secure digital (SD) card 1312, a multimedia card (MMC) card 1314, a memory stick (MS) 1316, a compact flash (CF) card 1318 or an embedded storage device 1320 (shown in FIG. 3). The embedded storage device 1320 includes an embedded MMC (eMMC). It should be noticed that the eMMC is directly coupled to a substrate of the host system.

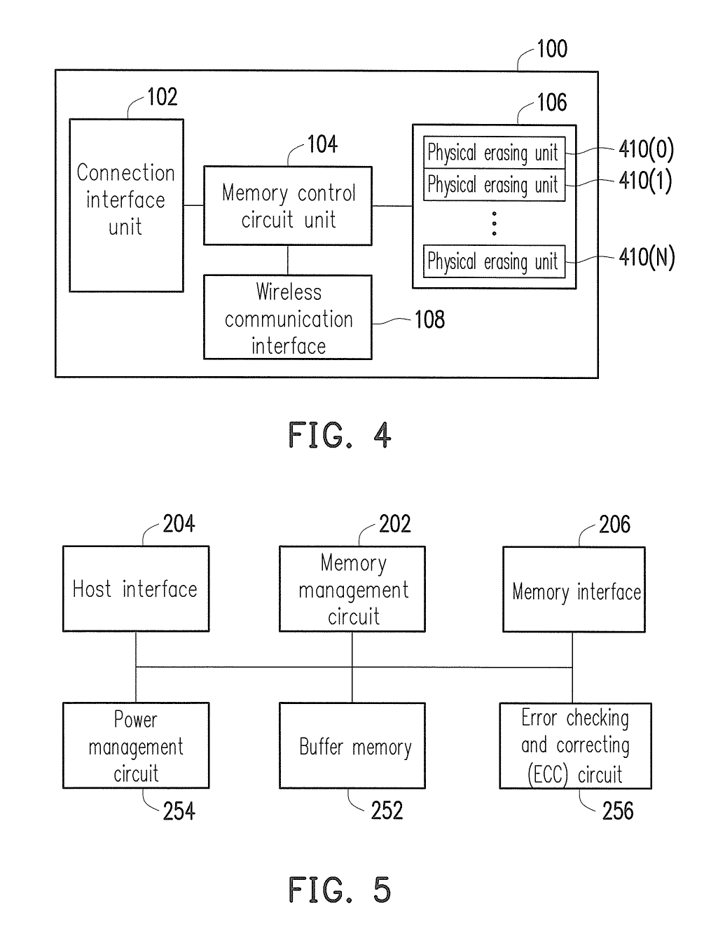

FIG. 4 is a schematic block diagram of a memory storage device according to an exemplary embodiment.

Referring to FIG. 4, the memory storage device 100 includes a connection interface unit 102, a memory control circuit unit 104, a rewritable non-volatile memory module 106 and a wireless communication interface 108. In the present exemplary embodiment, the memory storage device 100 is a flash drive. However, it should be noticed that in another exemplary embodiment, the memory storage device 100 can be a memory card or a solid state drive (SSD).

In the present exemplary embodiment, the connection interface unit 102 is complied with a universal serial bus (USB) standard. However, it should be noticed that the present disclosure is not limited thereto, and the connection interface unit 102 can also be complied with a parallel advanced technology attachment (PATA) standard, an institute of electrical and electronic engineers (IEEE) 1394 standard, a peripheral component interconnect express (PCI express) standard, a serial advanced technology attachment (SATA) standard, an ultra high speed-I (UHS-I) standard, an ultra high speed-II (UHS-II) standard, a secure digital (SD) interface standard, a memory stick (MS) interface standard, a multi media card (MMC) interface standard, a compact flash (CF) interface standard, an integrated drive electronics (IDE) interface standard or other suitable standards. In the present exemplary embodiment, the connection interface unit 102 and the memory control circuit unit 104 are packaged in a same chip or the connection interface unit 102 is configured outside a chip containing the memory control circuit unit 104.

The memory control circuit unit 104 may execute a plurality of logic gates or control instructions implemented by a hardware form or a firmware form, and may perform a program (i.e., write) operation, a read operation or an erase operation on the rewritable non-volatile memory module 106 according to operation commands of the host system 1000.

The rewritable non-volatile memory module 106 is coupled to the memory control circuit unit 104 and is configured for storing data written by the host system 1000. The rewritable non-volatile memory module 106 has physical erasing units 410(0)-410(N). For example, the physical erasing units 410(0)-410(N) are belonged to the same memory die or belonged to different memory dies. Each physical erasing unit has a plurality of physical programmable units, and the physical programmable units belonged to the same physical erasing unit are independently written and are simultaneously erased. For example, each physical erasing unit is composed of 128 physical programmable units. However, it should be noticed that the present disclosure is not limited thereto, and each physical erasing unit can be composed of 64 physical programmable units, 256 physical programmable units or any other number of the physical programmable units.

To be specific, each of the physical erasing units includes a plurality of word lines and a plurality of bit lines, and a memory cell is configured at an intersection of each of the word lines and each of the bit lines. Each of the memory cells may store one or a plurality of bits. In a physical erasing unit, all of the memory cells are erased all together. In the present exemplary embodiment, physical erasing unit is the smallest unit for erasing data. Namely, each physical erasing unit contains the least number of memory cells that are erased all together. For example, the physical erasing unit is a physical block. On the other hand, the memory cells on a same word line consist one or a plurality of physical programmable units. If one memory cell can store 2 or more bits, the physical programmable units on the same word line can be categorized into lower physical programmable units and upper physical programmable units. Generally, a writing speed of the lower physical programmable unit is greater than that of the upper physical programmable unit. In the present exemplary embodiment, physical programmable unit is the smallest unit for programming data. Namely, physical programmable unit is the smallest unit for writing data. For example, the physical programmable unit is a physical page or a physical sector. If the physical programmable unit is physical page, each physical programmable unit generally includes a data bit area and a redundant bit area. The data bit area includes a plurality of physical sectors, and is configured for storing user data, and the redundant bit area is configured for storing system data (for example, error checking and correcting (ECC) codes). In the present exemplary embodiment, each data bit area includes 32 physical sectors, and the size of one physical sector is 512 bytes (B). However, in other exemplary embodiments, the data bit area may also include 8, 16 or other number of the physical sectors, and the size and number of the physical sectors are not limited by the disclosure.

In the present exemplary embodiment, the rewritable non-volatile memory module 106 is a multi level cell (MLC) NAND flash memory module, i.e., one memory cell can store at least two bits. However, the disclosure is not limited thereto, and the rewritable non-volatile memory module 106 can also be a single level cell (SLC) NAND flash memory module, a trinary level cell (TLC) NAND flash memory module, other flash memory modules or other memory modules having the same characteristic.

The wireless communication interface 108 is coupled to the memory control circuit unit 104 and has a short-distance wireless communication function. The wireless communication interface 108 can be a communication chip supporting the short-distance wireless communication function such as bluetooth, wireless fidelity (Wi-Fi), near field communication (NFC), radio frequency identification (RFID), etc.

FIG. 5 is a schematic block diagram of a memory control circuit unit according to an exemplary embodiment.

Referring to FIG. 5, the memory control circuit unit 104 includes a memory management circuit 202, a host interface 204 and a memory interface 206.

The memory management circuit 202 is configured for controlling a whole operation of the memory control circuit unit 104. In detail, the memory management circuit 202 has a plurality of control instructions, and when the memory storage device 100 is in operation, these control instructions are executed to perform various operations, such as data write, read and erase operations. Description of the operations of the memory management circuit 202 is equivalent to description of the operations of the memory control circuit unit 104, which is not repeated.

In an exemplary embodiment, the control instructions of the memory management circuit 202 are implemented by a firmware form. For example, the memory management circuit 202 has a micro processing unit (not shown), a read-only memory (not shown) and a random access memory (not shown), and these control instructions are burned into the read-only memory. When the memory storage device 100 is in operation, these control instructions are executed by the micro processing unit to carry out various operations such as data write, read and erase operations.

In another exemplary embodiment, the control instructions of the memory management circuit 202 can also be stored in a specific area (for example, a system area used for storing system data in the rewritable non-volatile memory module) of the rewritable non-volatile memory module 106 as program codes. Moreover, the memory management circuit 202 has a micro processing unit (not shown), a read-only memory (not shown) and a random access memory (RAM) (not shown). Particularly, the read-only memory has a boot code, and when the memory control circuit unit 104 is enabled, the micro processing unit first executes the boot code to load the control commands stored in the rewritable non-volatile memory module 106 to the RAM of the memory management circuit 202. Then, the micro processing unit executes these control instructions to perform various operations such as data write, read and erase operations.

Moreover, in another exemplary embodiment, the control commands of the memory management circuit 202 can also be implemented in a hardware form. For example, the memory management circuit 202 includes a micro controller, a memory management unit, a memory writing unit, a memory reading unit, a memory erasing unit and a data processing unit. The memory management unit, the memory writing unit, the memory reading unit, the memory erasing unit and the data processing unit are coupled to the micro controller. The memory management unit is configured for managing the physical erasing units of the rewritable non-volatile memory module 106. The memory writing unit is configured for sending a write command to the rewritable non-volatile memory module 106 to write data to the rewritable non-volatile memory module 106. The memory reading unit is configured for sending a read command to the rewritable non-volatile memory module 106 to read data from the rewritable non-volatile memory module 106. The memory erasing unit is configured for sending an erase command to the rewritable non-volatile memory module 106 to erase data in the rewritable non-volatile memory module 106. The data processing unit is configured for processing data to be written to the rewritable non-volatile memory module 106 and data read from the rewritable non-volatile memory module 106.

The host interface 204 is coupled to the memory management circuit 202, and is configured for receiving and recognizing commands and data transmitted by the host system 1000. Namely, the commands and data transmitted by the host system 1000 are transmitted to the memory management circuit 202 through the host interface 204. In the present exemplary embodiment, the host interface 204 is complied with the USB standard. However, the present disclosure is not limited thereto, and the host interface 204 can also be complied with a parallel advanced technology attachment (PATA) standard, the IEEE 1394 standard, the PCI express standard, the SATA standard, the SD standard, the UHS-I standard, the UHS-II standard, the MS standard, the MMC standard, the eMMC standard, the UFS standard, the CF standard, the IDE standard or other suitable data transmission standards.

The memory interface 206 is coupled to the memory management circuit 202 and is configured to access the rewritable non-volatile memory module 106. Namely, data to be written into the rewritable non-volatile memory module 106 is converted into a format that can be accepted by the rewritable non-volatile memory module 106 through the memory interface 206.

The buffer memory 252 is coupled to the memory management circuit 202 and is configured to temporarily store data and commands come from the host system 1000 or data come from the rewritable non-volatile memory module 106.

In an exemplary embodiment, the memory management circuit 202 establishes a security channel with the electronic device 2000 (for example, a mobile phone of a user) through the wireless communication interface 108. For example, in case that the wireless communication interface 108 supports the bluetooth specification, the security channel can be established after a bluetooth pairing password is transmitted through the wireless communication interface 108 and is confirmed by the electronic device 2000.

The memory management circuit 202 acquires an identification code from the security channel established on the bluetooth communication through the wireless communication interface 108. The identification code can be one of a user identification code, a user password, a mobile phone identification code, a mobile phone password, etc. or a combination thereof, and can be input by the user through the electronic device 2000. However, the disclosure is not limited thereto, and the identification code can also be automatically input through an application program on the electronic device 2000.

When the memory management circuit 202 acquires the identification code, the memory management circuit 202 can use the identification code to acquire an encryption/decryption key, and stores the encryption/decryption key in the buffer memory 252. In detail, the rewritable non-volatile memory module 106 stores a personal identification code message digest and an encrypted key. The memory management circuit 202 has a one-way hash function, and can calculate a message digest corresponding to the aforementioned identification code by using the one-way hash function. In the present exemplary embodiment, the one-way hash function is implemented in the memory management circuit 202 by using SHA-256. However, the disclosure is not limited thereto. In another exemplary embodiment of the disclosure, the one-way hash function in the memory management circuit 202 can be implemented by MD5, RIPEMD-160, SHA1, SHA-386, SHA-512 or other suitable functions. Thereafter, the memory management circuit 202 compares the calculated message digest with the personal identification code message digest stored in the rewritable non-volatile memory module 106, and when the calculated message digest is complied with the personal identification code message digest stored in the rewritable non-volatile memory module 106, the memory management circuit 202 uses an encryption/decryption function to decode the encrypted key to acquire the encryption/decryption key. After the memory management circuit 202 acquires the encryption/decryption key, the memory management circuit 202 uses the encryption/decryption key to decode data read from the rewritable non-volatile memory module 106. Similarly, after the memory management circuit 202 acquires the encryption/decryption key, the memory management circuit 202 can use the encryption/decryption key to encrypt data to be written into the rewritable non-volatile memory module 106.

In the present exemplary embodiment, the encryption/decryption function in the memory management circuit 202 is implemented by an advanced encryption standard (AES) 128. However, the disclosure is not limited thereto, and in another exemplary embodiment of the disclosure, an AES256 or a data encryption standard (DES) can be used to implement the encryption/decryption function in the memory management circuit 202.

It should be noticed that the personal identification code message digest stored in the rewritable non-volatile memory module 106 is generated by using the aforementioned one-way hash function according to a personal identification code set by the user of the memory storage device 100. For example, when the memory storage device 100 is manufactured, the manufacturer pre-stores the personal identification code message digest, and the manufacturer provides a personal identification code corresponding to the personal identification code message digest to the user. Thereafter, the user can successfully pass through verification of the memory storage device 100 by using the personal identification code provided by the manufacturer. Moreover, when the user resets a new personal identification code, the memory management circuit 202 recalculates a new personal identification code message digest by using the one-way hash function according to the new personal identification code of the user, and stores the new personal identification code message digest in the rewritable non-volatile memory module 106 to replace the original personal identification code message digest. Then, the memory management circuit 202 uses the latest personal identification code message digest to verify the identification code input by the user.

Moreover, the encryption/decryption key is generated by a random number generator (not shown) in a random manner when the memory storage device 100 is manufactured. Particularly, the memory management circuit 202 uses the encryption/decryption function to encrypt the encryption/decryption key according to the personal identification code, and stores an encrypted key obtained by encrypting the encryption/decryption key in the memory storage device 100. Therefore, when the identification code passes through the above verification, the identification code can be used to correctly decode the encrypted key in the memory storage device 100, so as to acquire the encryption/decryption key.

In the present exemplary embodiment, after the memory management circuit 202 establishes the security channel with the electronic device 2000 through the wireless communication interface 108, the memory storage device 100 can send a polling signal to the electronic device 2000 every a predetermined time, for example, 5 seconds. When the electronic device 2000 receives the polling signal, the electronic device 2000 transmits an acknowledgement signal back to the memory storage device 100 to confirm a wireless connection status between the electronic device 2000 and the memory storage device 100. As long as the memory storage device 100 periodically receives the acknowledgement signal transmitted by the electronic device 2000 for replying the polling signal in such environment, the memory management circuit 202 may use the encryption/decryption key to access the rewritable non-volatile memory module 106.

Conversely, when the memory storage device 100 leaves such environment, if the memory storage device 100 does not receive the acknowledgement signal transmitted by the electronic device 2000 for replying the polling signal within a predetermined period of time, the memory management circuit 202 erases the encryption/decryption key in the buffer memory 252, and sets the memory storage device 100 to a non-media state. To be specific, when the memory storage device 100 is set to the non-media state, if the memory management circuit 202 receives an accessing signal transmitted by the host system 1000, the memory management circuit 202 replies a non-media signal to the host system 1000, such that the host system 1000 cannot identify or access the memory storage device 100. Namely, an operating system of the host system 1000 determines that the memory storage device 100 is in a connection interruption state. In this way, the others are hard to obtain the data stored in the rewritable non-volatile memory module 106, or even the others obtain the data, since the encryption/decryption key has been erased from the buffer memory 252, the others cannot decode the encrypted data in the rewritable non-volatile memory module 106.

In the aforementioned description, the user inputs the identification code through the electronic device 2000, and the identification code is transmitted through the bluetooth wireless communication network to ensure security of the memory storage device 100, though the disclosure is not limited thereto. In another exemplary embodiment, the memory storage device 100 can use the personal identification code message digest stored therein to log in a Wi-Fi wireless communication network environment of one access point (AP), and in the present embodiment, the electronic device 2000 can be a server connected to the access point. After the memory storage device 100 logs in the Wi-Fi by using the personal identification code message digest, the server searches an identification code corresponding to the personal identification code message digest, and transmits the identification code to the memory storage device 100 through the access point. The memory storage device 100 receives the identification code and generates a message digest corresponding to the identification code by using the one-way hash function. If the message digest is the same to the personal identification code message digest stored in the memory storage device 100, the identification code can be used to correctly decode the encrypted key stored in the memory storage device 100, so as to acquire the encryption/decryption key. Therefore, the user can access the memory storage device 100 through the encryption/decryption key.

In another exemplary embodiment, the memory storage device 100 can use a predetermined login code to log in the access point. Here, the electronic device 2000 may be a server connected to the access point. After the memory storage device 100 successfully logs in the access point and establishes the Wi-Fi network connection, the user can directly input the identification code at the access point by using an input device, such that the identification code is transmitted to the memory storage device 100 through the access point. Then, the memory storage device 100 receives the identification code and generates the message digest corresponding to the identification code by using the one-way hash function. If the message digest is the same to the personal identification code message digest stored in the memory storage device 100, the identification code can be used to correctly decode the encrypted key stored in the memory storage device 100, so as to acquire the encryption/decryption key. Therefore, the user can access the memory storage device 100 through the encryption/decryption key.

It should be noticed that when the memory storage device 100 enters the aforementioned Wi-Fi wireless communication network environment, the memory storage device 100 may acquire a data transmission key from the electronic device 2000, so as to encrypt or decrypt data transmitted or received in such wireless communication network environment. For example, when the memory storage device 100 successfully logs in the aforementioned Wi-Fi wireless communication network environment, the memory storage device 100 may receive a data transmission key from the electronic device 2000 and stores the data transmission key in the buffer memory 252. The electronic device 2000 first uses the data transmission key to encrypt the identification code before transmitting the identification code. When the memory storage device 100 receives data transmitted by the electronic device 2000 in the Wi-Fi environment, i.e., receives the identification code encrypted by using the data transmission key, the memory storage device 100 decrypts the data to acquire the identification code by using the data transmission key stored in the buffer memory 252.

In an exemplary embodiment of the disclosure, the memory control circuit unit 104 further includes a power management circuit 254 and an error checking and correcting (ECC) circuit 256.

The power management circuit 254 is coupled to the memory management circuit 202 and is configured to control the power of the memory storage device 100.

The ECC circuit 256 is coupled to the memory management circuit 202 and is configured to execute an error checking and correcting procedure to ensure correctness of data. In detail, when the memory management circuit 202 receives a write command from the host system 1000, the ECC circuit 256 generates a corresponding error checking and correcting code (ECC code) for data corresponding to the write command, and the memory management circuit 202 writes the data corresponding to the write command and the corresponding ECC code together to the rewritable non-volatile memory module 106. Then, when the memory management circuit 202 reads data from the rewritable non-volatile memory module 106, it simultaneously reads the ECC code corresponding to the data, and the ECC circuit 256 executes the error checking and correcting procedure on the read data according to the ECC code.

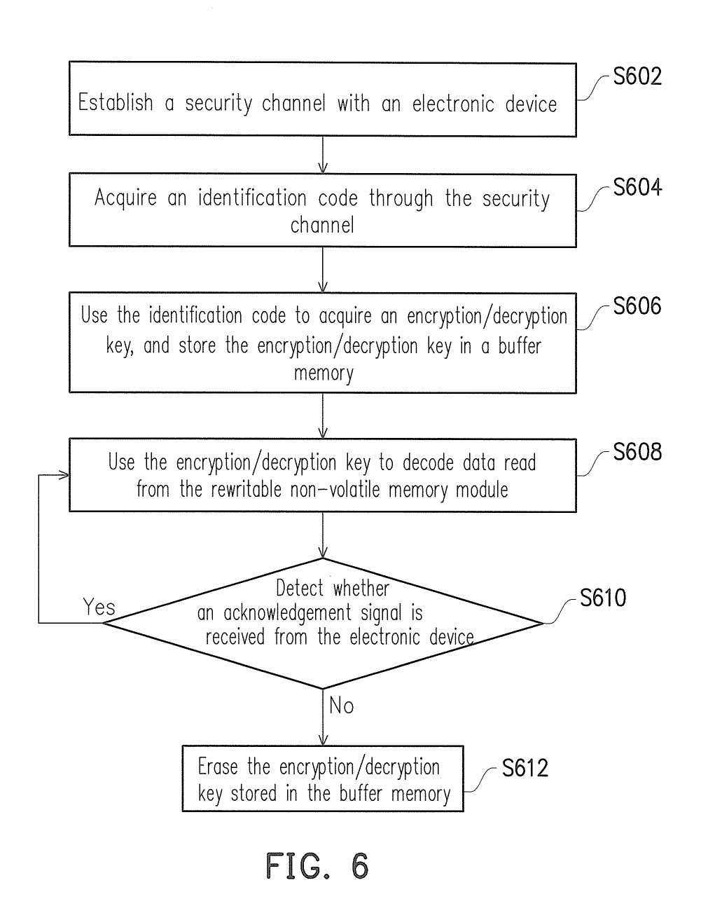

FIG. 6 is a flowchart illustrating a data protection method according to an exemplary embodiment.

Referring to FIG. 6, in step S602, the memory management circuit establishes a security channel with the electronic device 2000 through the wireless communication interface 108. The security channel can be established after a wireless network pairing identification code is transmitted through the wireless communication interface 108 and is confirmed by the electronic device 2000.

After the security channel is established between the memory storage device 100 and the electronic device 2000, step S604 is executed, by which the memory management circuit 202 acquires an identification code from the security channel through the wireless communication interface 108. Here, the identification code can be input by the user through the electronic device 2000 or can also be automatically input through an application program on the electronic device 2000.

In step S606, the memory management circuit 202 uses the identification code to acquire an encryption/decryption key, and stores the encryption/decryption key in the buffer memory 252.

After the memory management circuit 202 acquires the encryption/decryption key, a step S608 is executed, by which the encryption/decryption key and an encryption/decryption function are used to access data in the rewritable non-volatile memory module 106. In detail, when the user wants to write data into the rewritable non-volatile memory module 106, the memory management circuit 202 can encrypt the write data by using the AES according to the encryption/decryption key, and writes the encrypted data into the rewritable non-volatile memory module 106. Similarly, when the user wants to read data from the rewritable non-volatile memory module 106, the memory management circuit 202 can decrypt the data by using the AES according to the encryption/decryption key, and reads the decrypted data. It should be noticed that besides that the user can access the data in the rewritable non-volatile memory module 106 through a wired interface such as USB or SATA, etc., the user can also access the data in the rewritable non-volatile memory module 106 through the wireless communication interface 108 from a remote end via a wireless network.

After the memory management circuit 202 establishes the security channel with the electronic device 2000 through the wireless communication interface 108, the electronic device 2000 replies a polling signal of the memory storage device 100 to send an acknowledgement signal to the memory storage device 100, so as to confirm a wireless connection state of the electronic device 2000 and the memory storage device 100. In step S610, the wireless communication interface 108 detects whether the acknowledgement signal is received from the electronic device 2000 through the security channel established on the wireless communication network. If the wireless communication interface 108 detects the acknowledgement signal, the flow returns to the step S608, by which the data in the rewritable non-volatile memory module 106 is continually accessed.

If the wireless communication interface 108 of the memory storage device 100 does not receive the acknowledgement signal from the electronic device 2000 within a predetermined period of time, for example, 10 seconds, it represents that the electronic device 2000 is no longer within the short-distance wireless communication range of the wireless communication interface 108, and in step S612, the memory management circuit 202 erases the encryption/decryption key stored in the buffer memory 252, and sets the memory storage device 100 to the non-media state. To be specific, when the memory storage device 100 is set to the non-media state, if the memory management circuit 202 receives an accessing signal transmitted by the host system 1000, the memory management circuit 202 replies a non-media signal to the host system 1000, such that the host system 1000 cannot identify or access the memory storage device 100. Namely, an operating system of the host system 1000 determines that the memory storage device 100 is in a connection interruption state. In this way, the others are hard to obtain the data stored in the rewritable non-volatile memory module 106, or even the others obtain the data, since the encryption/decryption key has been erased from the buffer memory 252, the others cannot decode the encrypted data in the rewritable non-volatile memory module 106.

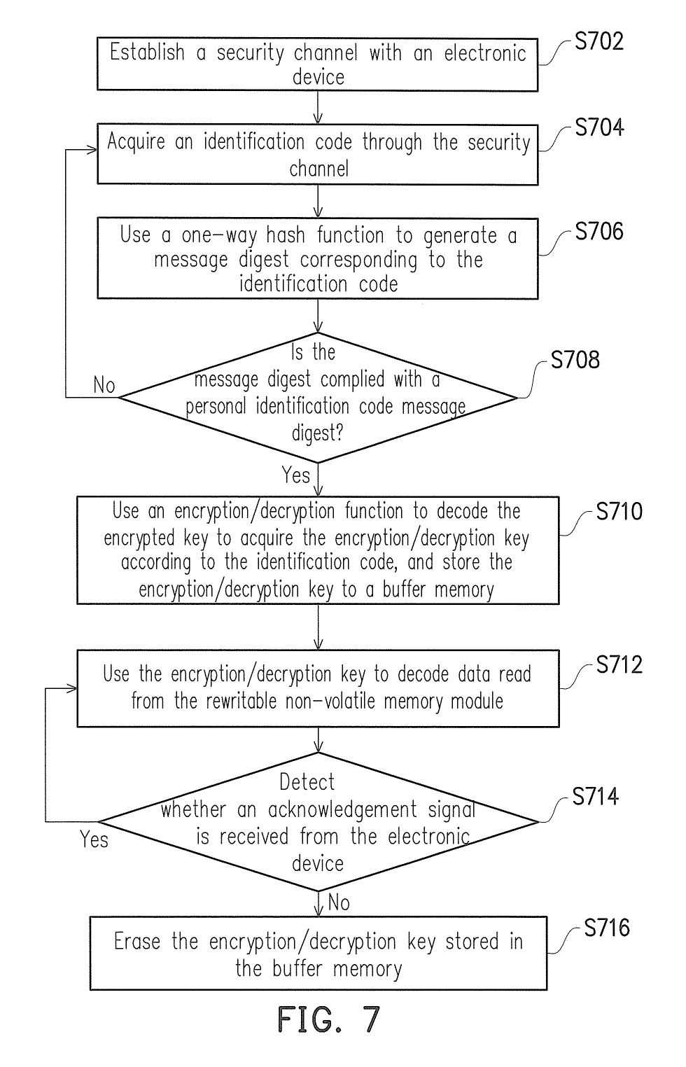

FIG. 7 is a flowchart illustrating a data protection method according to another exemplary embodiment.

Referring to FIG. 7, in step S702, the memory management circuit 202 establishes a security channel with the electronic device 2000 through the wireless communication interface 108, where the security channel may be established after a wireless network pairing identification code is transmitted through the wireless communication interface 108 and is confirmed by the electronic device 2000.

After the security channel is established between the memory storage device 100 and the electronic device 2000, step S704 is executed, by which the memory management circuit 202 acquires an identification code from the security channel through the wireless communication interface 108. Here, the identification code can be input by the user through the electronic device 2000 or can also be automatically input through an application program on the electronic device 2000.

In step S706, the memory management circuit 202 operates the received identification code by using a hash function to generate a corresponding message digest, and in step S708, the memory management circuit 202 determines whether the message digest is complied with a personal identification code message digest. Here, the personal identification code message digest and an encrypted key are pre-stored in the rewritable non-volatile memory module 106, where the personal identification code message digest is initially generated by using the one-way hash function according to a personal identification code, and the encrypted key is initially generated by encrypting a randomly generated encryption/decryption key by using an encryption/decryption function such as the AES or a data encryption standard according to the personal identification code.

If the memory management circuit 202 determines that the message digest is not complied with the personal identification code message digest, the flow returns to the step S704, by which the identification code is again acquired from the electronic device 2000. If the memory management circuit 202 determines that the message digest is complied with the personal identification code message digest, in step S710, the memory management circuit 202 decodes the encrypted key to acquire an encryption/decryption key by using the encryption/decryption function according to the identification code, and stores the encryption/decryption key to the buffer memory 252.

After acquiring the encryption/decryption key, in step S712, the memory management circuit 202 uses the encryption/decryption key and the encryption/decryption function to access data in the rewritable non-volatile memory module 106. Since the process of accessing the data in the rewritable non-volatile memory module 106 by using the encryption/decryption key and the encryption/decryption function has been described in the embodiment of FIG. 6, details thereof are not repeated.

After the memory management circuit 202 establishes the security channel with the electronic device 2000 through the wireless communication interface 108, the electronic device 2000 replies a polling signal of the memory storage device 100 to send an acknowledgement signal to the memory storage device 100, so as to confirm a wireless connection state of the electronic device 2000 and the memory storage device 100. In step S714, the wireless communication interface 108 detects whether the acknowledgement signal is received from the electronic device 2000 through the security channel established on the wireless communication network. If the wireless communication interface 108 detects the acknowledgement signal, the flow returns to the step SS712, by which the data in the rewritable non-volatile memory module 106 is continually accessed.

If the wireless communication interface 108 of the memory storage device 100 does not receive the acknowledgement signal from the electronic device 2000 within a predetermined period of time, for example, 10 seconds, it represents that the electronic device 2000 is no longer within the short-distance communication range of the wireless communication interface 108, and in step S716, the memory management circuit 202 erases the encryption/decryption key stored in the buffer memory 252, and sets the memory storage device 100 to the non-media state. To be specific, when the memory storage device 100 is set to the non-media state, if the memory management circuit 202 receives an accessing signal transmitted by the host system 1000, the memory management circuit 202 replies a non-media signal to the host system 1000, such that the host system 1000 cannot identify or access the memory storage device 100. Namely, an operating system of the host system 1000 determines that the memory storage device 100 is in a connection interruption state. In this way, the others are hard to obtain the data stored in the rewritable non-volatile memory module 106, or even the others obtain the data, since the encryption/decryption key has been erased from the buffer memory 252, the others cannot decode the encrypted data in the rewritable non-volatile memory module 106, so as to achieve the effect of protecting the data in the storage device.

In summary, in the data protection method, the memory control circuit unit and the memory storage device of the disclosure, the security channel between the memory storage device and the electronic device is established, and the encryption/decryption key is acquired according to the identification code transmitted by the electronic device through the wireless network, so as to access the rewritable non-volatile memory module. When the acknowledgement signal is not received from the electronic device within a predetermined period of time, the memory storage device determines that it is not within the range of the short-distance wireless communication network of the electronic device, and erases the encryption/decryption key in the buffer memory. In this way, the memory storage device cannot normally operate once it is away from the handheld electronic device of the user or is not within a specific wireless network environment. Even if the memory storage device is possessed by others, the encrypted data in the rewritable non-volatile memory module cannot be decoded as the encryption/decryption key is erased, so as to ensure security of the data in the memory storage device. The previously described exemplary embodiments of the present invention have the advantages aforementioned, wherein the advantages aforementioned not required in all versions of the invention.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A data protection method for protecting data of a rewritable non-volatile memory module in a memory storage device, the data protection method comprising:
establishing a security channel with an electronic device through a wireless communication network;
acquiring an identification code through the security channel established on the wireless communication network;
using the identification code to acquire an encryption/decryption key, and storing the encryption/decryption key in a buffer memory;
using the encryption/decryption key to decode data read from the rewritable non-volatile memory module, wherein the data in the rewritable non-volatile memory module is encoded by using the encryption/decryption key;
detecting whether an acknowledgement signal is received from the electronic device through the security channel established on the wireless communication network; and
erasing the encryption/decryption key stored in the buffer memory if the acknowledgement signal is not received from the electronic device within a predetermined period of time.

2. The data protection method as claimed in claim 1, further comprising:
setting the memory storage device to a non-media state after erasing the encryption/decryption key stored in the buffer memory.

3. The data protection method as claimed in claim 1, wherein the step of acquiring the identification code through the security channel established on the wireless communication network comprises:
acquiring the identification code input through the electronic device through the security channel established on the wireless communication network, wherein the electronic device is a handheld electronic device.

4. The data protection method as claimed in claim 1, wherein the step of acquiring the identification code through the security channel established on the wireless communication network comprises:
acquiring the identification code generated by the electronic device through the security channel established on the wireless communication network, wherein the electronic device is a server and is coupled to a wireless network access point.

5. The data protection method as claimed in claim 1, wherein the wireless communication network is a bluetooth network, a wireless fidelity network, a near field communication network, or a radio frequency identification network.

6. The data protection method as claimed in claim 1, wherein the step of using the identification code to acquire the encryption/decryption key, and storing the encryption/decryption key in the buffer memory comprises:
storing a personal identification code message digest and an encrypted key in the rewritable non-volatile memory module;
using a one-way hash function to generate a message digest corresponding to the identification code; and
determining whether the message digest is complied with the personal identification code message digest, wherein when the message digest is complied with the personal identification code message digest, the encrypted key is decoded to obtain the encryption/decryption key by using an encryption/decryption function according to the identification code.

7. The data protection method as claimed in claim 6, further comprising:
initially generating the personal identification code message digest by using the one-way hash function according to a personal identification code; and
initially generating the encrypted key by encrypting the encryption/decryption key by using the encryption/decryption function according to the personal identification code.

8. The data protection method as claimed in claim 7, wherein the step of initially generating the encrypted key by encrypting the encryption/decryption key by using the encryption/decryption function according to the personal identification code further comprises:
initially generating the encryption/decryption key in a random manner.

9. The data protection method as claimed in claim 1, wherein the step of using the encryption/decryption key to decode data read from the rewritable non-volatile memory module comprises:
using an encryption/decryption function to decode the data read from the rewritable non-volatile memory module according to the encryption/decryption key, wherein the data of the rewritable non-volatile memory module is encrypted by using the encryption/decryption function according to the encryption/decryption key.

10. A memory control circuit unit for controlling a rewritable non-volatile memory module, the memory control circuit unit comprising:
a host interface configured to couple to a host system;
a memory interface configured to couple to the rewritable non-volatile memory module; and
a memory management circuit coupled to the host interface and the memory interface,
wherein the memory control circuit unit establishes a security channel with an electronic device through a wireless communication network via a wireless communication interface,
wherein the wireless communication interface acquires an identification code through the security channel established on the wireless communication network,
wherein the memory management circuit uses the identification code to acquire an encryption/decryption key, and stores the encryption/decryption key in a buffer memory,
wherein the memory management circuit uses the encryption/decryption key to decode data read from the rewritable non-volatile memory module, wherein the data in the rewritable non-volatile memory module is encoded by using the encryption/decryption key,
wherein the wireless communication interface detects whether an acknowledgement signal is received from the electronic device through the security channel established on the wireless communication network,
wherein the memory management circuit erases the encryption/decryption key stored in the buffer memory if the wireless communication interface does not receive the acknowledgement signal from the electronic device within a predetermined period of time.

11. The memory control circuit unit as claimed in claim 10, wherein after the memory management circuit erases the encryption/decryption key stored in the buffer memory, when the memory management circuit receives an accessing signal from the host system, the memory management circuit transmits a non-media signal to the host system.

12. The memory control circuit unit as claimed in claim 10, wherein the wireless communication network is a bluetooth network, a wireless fidelity network, a near field communication network, or a radio frequency identification network.

13. The memory control circuit unit as claimed in claim 10, wherein the memory management circuit stores a personal identification code message digest and an encrypted key in the rewritable non-volatile memory module,
wherein the memory management circuit uses a one-way hash function to generate a message digest corresponding to the identification code,
wherein the memory management circuit determines whether the message digest is complied with the personal identification code message digest, wherein when the message digest is complied with the personal identification code message digest, the memory management circuit decodes the encrypted key to obtain the encryption/decryption key by using an encryption/decryption function according to the identification code.

14. A memory storage device, comprising:
a connection interface unit configured to couple to a host system;
a rewritable non-volatile memory module;
a memory control circuit unit coupled to the connection interface unit and the rewritable non-volatile memory module; and
a wireless communication interface coupled to the memory control circuit unit,
wherein the memory control circuit unit establishes a security channel with an electronic device through a wireless communication network via the wireless communication interface,
wherein the memory control circuit unit acquires an identification code through the security channel established on the wireless communication network,
wherein the memory control circuit unit uses the identification code to acquire an encryption/decryption key, and stores the encryption/decryption key in a buffer memory,
wherein the memory control circuit unit uses the encryption/decryption key to decode data read from the rewritable non-volatile memory module, wherein the data in the rewritable non-volatile memory module is encoded by using the encryption/decryption key,
wherein the memory control circuit unit detects whether an acknowledgement signal is received from the electronic device through the security channel established on the wireless communication network,
wherein the memory control circuit unit erases the encryption/decryption key stored in the buffer memory if the memory control circuit unit does not receive the acknowledgement signal from the electronic device within a predetermined period of time.

15. The memory storage device as claimed in claim 14, wherein after the memory control circuit unit erases the encryption/decryption key stored in the buffer memory, when the memory control circuit unit receives an accessing signal from the host system, the memory control circuit unit transmits a non-media signal to the host system.

16. The memory storage device as claimed in claim 14, wherein the memory control circuit unit acquires the identification code input through the electronic device through the security channel established on the wireless communication network, wherein the electronic device is a handheld electronic device.

17. The memory storage device as claimed in claim 14, wherein the memory control circuit unit acquires the identification code generated by the electronic device through the security channel established on the wireless communication network, wherein the electronic device is a server and is coupled to a wireless network access point.

18. The memory storage device as claimed in claim 14, wherein the wireless communication network is a bluetooth network, a wireless fidelity network, a near field communication network, or a radio frequency identification network.

19. The memory storage device as claimed in claim 14, wherein the memory control circuit unit stores a personal identification code message digest and an encrypted key in the rewritable non-volatile memory module,
wherein the memory control circuit unit uses a one-way hash function to generate a message digest corresponding to the identification code,
wherein the memory control circuit unit determines whether the message digest is complied with the personal identification code message digest, wherein when the message digest is complied with the personal identification code message digest, the memory control circuit unit decodes the encrypted key to obtain the encryption/decryption key by using an encryption/decryption function according to the identification code.

20. The memory storage device as claimed in claim 19, wherein the memory control circuit unit initially generates the personal identification code message digest by using the one-way hash function according to a personal identification code,
wherein the memory control circuit unit initially generates the encrypted key by encrypting the encryption/decryption key by using the encryption/decryption function according to the personal identification code.

21. The memory storage device as claimed in claim 20, wherein the memory control circuit unit initially generates the encryption/decryption key in a random manner.

22. The memory storage device as claimed in claim 14, wherein the memory control circuit unit uses an encryption/decryption function to decode the data read from the rewritable non-volatile memory module according to the encryption/decryption key, wherein the data of the rewritable non-volatile memory module is encrypted by using the encryption/decryption function according to the encryption/decryption key.
